(19) United States
(12) Patent Application Publication
(10) Pub. No.: US 2018/0044239 A1
(43) Pub. Date: Feb. 15, 2018

(54) MODIFIED CELLULOSE ETHER WITH IMPROVED WORKABILITY FOR USE IN GYPSUM SMOOTHING MORTAR AND JOINT FILLER APPLICATIONS

(71) Applicant: Dow Global Technologies LLC, Midland, MI (US)

(72) Inventors: Sonja Menz, Wedemark (DE); Anette Wagner, Walsrode (DE)

(21) Appl. No.: 15/558,082

(22) PCT Filed: Mar. 28, 2016
(86) PCT No.: PCT/US2016/024443

§ 371 Date: Sep. 13, 2017

Related U.S. Application Data
(60) Provisional application No. 62/139,857, filed on Mar. 30, 2015.

(51) Int. Cl. C04B 24/38; C04B 24/28; C04B 40/00; C04B 28/14; C04B 24/26

(52) U.S. Cl. CPC C04B 24/383; C04B 28/14; C04B 24/2652; C04B 40/0042; C04B 24/2623; C04B 24/283; C04B 2111/00672

(57) ABSTRACT

The present invention provides additives for dry mix or tape joint compound compositions comprising one or more cellulose ether powders containing on its surface a polymeric additive chosen from polymeric colloidal stabilizers, polymeric fluidizers and combinations thereof. The additive is formed by methods of kneading at from 50 to 120° C. a wet cellulose ether mixture containing from 60 to 80 wt. % of water with from 0.1 to 10 wt. %, based on total cellulose ether solids, of a polymeric additive chosen from polymeric colloidal stabilizers, and polymeric fluidizers, and combinations thereof to form the additive; drying and grinding the additive; and, combining the additive with 0.1 to 20 wt. %, based on total cellulose ether solids, of a dry polyacrylamide.

The present invention relates to methods for making compositions for use as dry mix additives comprising kneading wet cellulose ether at an elevated temperature, for example, from 50 to 120° C., and a polymeric additive chosen from polymeric colloidal stabilizers, e.g., polyvinyl alcohol, and polymeric fluidizers, such as superplasticizers, like polycarboxylate ethers, and combinations thereof as well as dry mixes containing the compositions made by the methods of the present invention.

Workability as well as compressive and flexural strength are very important performance criteria for gypsum smoothing mortars and joint filler compositions that are used, respectively, to finish gypsum or plaster surfaces and sheet rock or gypsum board joints and surface irregularities. Lump formation in these compositions when combined with water or moisture is caused by the given very fine gypsum particle size (less than 315 μm (not greater than 1 wt. %. retained on a 200 μm sieve (DIN EN 13963 (2011-11)); and the avoidance of lump formation is the major point in the context of workability. Curing to a consistent compressive and flexural strength is critical in the context of the final properties of the materials.

To improve workability of gypsum smoothing mortar and joint filler, known approaches include blending dry cellulose ether with polyacrylamide. Alternative additives, like water reducers (superplasticizers) or polycarboxylate dispersant polymers have also been used. For example, German patent DE3920025A1 for “Additive mixtures for gypsum materials containing cellulose derivs., thickeners and fluidizers”, to Aqualon GmbH, describes the use of calcium ligninsulfonate as superplasticizer to modify methyl cellulose compositions containing a thickener to improve the workability is known. However, especially in view of the inconsistency naturally inherent in gypsum, the workability of such gypsum smoothing mortar and tape joint dry mix and liquid compositions in use still needs improvement.

The present invention seeks to solve the problems of providing cellulose ether additive compositions that give gypsum smoothing mortar and tape joint compounds improved workability as a mortar and improved compressive and flexural strength when cured.

### STATEMENT OF THE INVENTION

1. In accordance with the present invention methods for making compositions for use as gypsum dry mix or liquid tape joint compound additives comprise kneading at elevated temperature of from 50 to 120° C. or, preferably, from 60 to 80° C., a wet cellulose ether mixture containing from 60 to 80 wt. % of water, one or more cellulose ether, preferably, the cellulose ether being a hydroxyethyl methyl cellulose or methyl cellulose, and from 0.1 to 10 wt. %, or, preferably, from 0.2 to 5 wt. % or, more preferably, from 0.3 to 5 wt. %, as solids, based on total cellulose ether solids, of a polymeric additive chosen from polymeric colloidal stabilizers, preferably, polyvinyl alcohol, and polymeric fluidizers, such as superplasticizers, preferably, polycarboxylate ethers, or, more preferably, polyacrylic or polymethacrylic acids containing one or more alkylpolyglycol ether side chains, and combinations thereof to form an additive; drying and grinding the additive to an average particle size of at least 25 wt. %<63 μm (measured by light scattering), or, preferably, at least 30 wt. %<63 μm (measured by light scattering); and, combining the additive with a total of from 0.1 to 20 wt. %, or, preferably, from 0.1 to 4 wt. %, based on total cellulose ether solids of one or more dry polyacrylamide.

2. In accordance with the methods of item 1, above wherein the kneading device comprises an extruder, such as a single-screw extruder or a multi-screw extruder; a kneader; a banbury mixer; a high shear mixer, such as a continuous inline mixer, for example, an IKA high-shear mixer, Oakes rotor stator mixer, Ross mixer, Silverson mixer, a continuous high shear mixer; or a homogenizer.

3. In accordance with the methods of any of items 1 or 2, above, the polymeric additive is a polymeric fluidizer as an aqueous composition having from 10 to 50 wt. % solids.

4. In accordance with the methods of any one of items 1, 2, or 3, above, wherein the polymeric additive is a polymeric fluidizer chosen from a polycarboxylate ether, and a melamin/formaldehyde sulfonate.

5. In accordance with the methods of any one of items 1 or 2, above, the polymeric additive is a polymeric colloidal stabilizer as an aqueous composition having from 5 to 30 wt. % solids.

6. In another aspect of the present invention, dry mix compositions comprise gypsum or calcium sulfate and a dry mix additive comprising (i) one or more cellulose ether powders wherein the cellulose ether powder contains on its surface from 0.1 to 10 wt. %, or, preferably, from 0.2 to 5 wt. % or, more preferably, from 0.3 to 5 wt. %, as solids, based on total cellulose ether solids, of a polymeric additive chosen from polymeric colloidal stabilizers, preferably, polyvinyl alcohol, and polymeric fluidizers, such as superplasticizers, preferably, polycarboxylate ethers, or, more preferably, polyacrylic or polymethacrylic acids containing one or more alkylpolyglycol ether side chains, the dry mix additive further comprising (ii) a polyacrylamide in the amount of from 0.1 to 20 wt. % or, preferably, from 0.1 to 4 wt. %, based on total cellulose ether solids.

7. In accordance with the dry mix composition of items 6, above, wherein the gypsum or calcium sulfate is substantially free from calcium sulfate hemihydrate.

8. In accordance with the dry mix composition of any one of items 6 or 7, above, further comprising one or more inorganic filler, such as talc or calcium carbonate.

9. In accordance with the dry mix composition of any one of items 6, 7 or 8, above, further comprising one or more water redispersible polymer powder of an emulsion polymer, such as an acrylic emulsion polymer or a vinyl ester emulsion polymer, such as ethylene-vinyl acetate.

10. In accordance with the dry mix composition of any one of items 6, 7, 8, or 9, above, wherein the dry mix additive is a powder having an average particle size of at least 25 wt. %<63 μm (measured by light scattering), or, preferably, at least 30 wt. %<63 μm (measured by light scattering).

Unless otherwise indicated, all temperature and pressure units are room temperature and standard pressure (STP).

All phrases comprising parentheses denote either or both of the included parenthetical matter and its absence. For example, the phrase “(meth)acrylate” includes, in the alternative, acrylate and methacrylate.

All ranges recited are inclusive and combinable. For example, a disclosure of from 50 to 120° C. or, preferably, from 60 to 100° C. will include all of from 50 to 120° C., from 50 to 60° C., from 60 to 120° C., from 100 to 120° C., from 50 to 100° C. or, preferably, from 60 to 100° C.

By “aqueous” herein is meant that the continuous phase is water and from 0% to 10%, by weight based on the weight of the medium, of water-miscible compound(s). Preferred is water.

As used herein, the phrase “based on total solids” refers to weight amounts of any given ingredient in comparison to the total weight amount of all of the non-volatile ingredients in the aqueous composition, including synthetic polymers, cellulose ethers, fillers, other inorganic materials, and other non-volatile additives. Water is not considered a solid.

As used herein the term “DIN EN” refers to a English language version of a German materials specification, published by Beuth Verlag GmbH, Berlin, DE (Alleinverkauf). And, as used herein, the term “DIN” refers to the German language version of the same materials specification.

By “dry mix” herein is meant a storage stable powder containing gypsum, cellulose ether, any polymeric additive, and any fillers and dry additives. No water is present in a dry mix; hence it is storage stable.

By “substantially free from calcium sulfate hemihydrate” herein is meant that the level of calcium sulfate hemihydrate is less than 1 wt. %, preferably less than 0.5 wt. %, more preferably less than 0.1 wt. % based on the weight of the gypsum or calcium sulfate solids.

Kneading polymeric fluidizers, for example, superplasticizers at elevated temperature in combination with cellulose ethers dramatically improves the workability of a resulting gypsum containing product or mortar. Further, kneading polymeric colloidal stabilizers, for example, polyvinyl alcohol (PVOH) at elevated temperature in combination with cellulose ethers dramatically improves the flexural and compressive strength of a resulting gypsum containing cured material. In the present invention, the methods lead to cellulose ether, e.g., HEMC, particles or domains coated with the polymeric additive. The workability of the gypsum mortar is not affected by PVOH addition; and any lump formation issues generated by modifying agents such as polymeric colloidal stabilizers is avoided. The incorporated polymeric fluidizers, e.g., superplasticizers show no negative impact on cured gypsum mortar; so, the measured values for compressive and flexural strength are at comparable level for cellulose ethers, like HEMC when used in a conventional manner.

During kneading, the water content in the kneading device should range from 60 to 80 weight % of the mixture being kneaded to keep up proper pressure to effect kneading and avoid damaging the kneader or its contents.

During kneading, the temperature of the contents in the kneader should be kept elevated to enable improved mixing, and not exceed the gel point of the cellulose ether to avoid agglomeration. Because kneading is continued for a short time period, the kneader itself may be set at a temperature well above the gel point of the cellulose ether without the contents in the kneader exceeding the gel point of the cellulose ether during kneading.

Kneading may be continued for a time of from 10 to 120 minutes, or, preferably, from 20 to 60 minutes. Kneading may be carried out in one, two or more than two stages.

Any cellulose ether that is soluble in water at 20° C. may be used in the present invention. In such compounds, the hydroxyl groups present in cellulose may be partially or fully replaced by —OR groups, wherein R is selected from a (C₁-C₆) alkyl group, a hydroxy(C₁-C₆)alkyl group and mixtures thereof. The presence of an alkyl substitution in cellulose ethers is conventionally described by the DS, i.e., the average number of substituted OH groups per anhydroglucose unit. For example, a methyl substitution is specified as DS (methyl) or DS (M). Similarly, the presence of a hydroxyalkyl substitution is conventionally described by the MS, i.e., the average number of moles of the esterification reagent which are bound in an ether-like manner per mole of anhydroglucose units. For example, the etherification with the ethylene oxide is stated as MS (hydroxyethyl) or MS (HE) and the etherification with propylene oxide as MS (hydroxypropyl) or MS (HP). The determination of the DS and MS is effected by the Zeisel method which is described, for example, in P. W. Morgan, Ind. Eng. Chem. Anal. Ed. 18 (1946) 500-504, and R. U. Lemieux, C. B. Purves, Can. J. Res. Sect. B 25 (1947) 485-489.

Suitable cellulose ethers for use in the methods of the present invention may include, for example, a hydroxyalkyl cellulose or an alkyl cellulose, or a mixture of such cellulose ethers. Examples of cellulose ether compounds suitable for use in the present invention include, for example, methylcellulose (MC), ethyl cellulose, propyl cellulose, butyl cellulose, hydroxyethyl methylcellulose (NEMC), hydroxypropyl methylcellulose (HPMC), hydroxyethyl cellulose (“HEC”), ethylhydroxyethylcellulose (EHEC), methylethylhydroxyethylcellulose (MEHEC), hydrophobically modified ethylhydroxyethylcelluloses (H MEHEC), hydrophobically modified hydroxyethylcelluloses (HMHEC), sulfoethyl methyl hydroxyethylcelluloses (SEMHEC), sulfoethyl methylhydroxypropylcelluloses (SEMHPC), and sulfoethyl hydroxyethylcelluloses (SEHEC). Preferably, the cellulose ethers are binary mixed ethers, such as hydroxyethyl methylcellulose (“NEMC”), hydroxypropyl methylcellulose (“HPMC”) and ethylhydroxyethyl cellulose.

Suitable polymeric fluidizers for use in the methods of the present invention may consist of any of a polycarboxylate ethers (PCE), such as carboxylic acid salt polymers with long polyethylene glycol side chains, and water-soluble polycondensation products of fatty acids, dialkanolamine and maleic anhydride, condensation products of lignin sulfonates, melamin/formaldehyde sulfonates, naphthalene sulfonic acid/formaldehyde condensates containing sulfonate or sulfonic acid groups, and arylsulfonic acid-formaldehyde-condensation products. Suitable polymeric fluidizers are available under either the trade name Glenium™ 51 polymethacrylic acid polycarboxylates containing esterified methyl polyethylene glycol side chains, or the trade name Melment™ sulfonated melamine/formaldehyde resin condensates (both from BASF, Ludwigshafen, DE).

Suitable polymeric colloidal stabilizers for use in the methods of the present invention may include polyvinyl alcohol (PVOH) and polyvinyl alcohol-co-vinylester copolymers. PVOH may be prepared, for example, by polymerizing vinyl acetate followed by a partially alkaline hydrolysis thereof to hydrolyze some or all of the ester groups.

Suitable polyacrylamide polymers for use in the methods of the present invention may be polymers of an acrylamide, methacrylamide, N-methylacrylamide, N,N-dimethylacrylamide. Preferred acrylamides have GPC (pAA) weight average molecular weights in the range of from 1 to several millions. Non-ionic polyacrylamide compounds preferably have average molecular weights in the range of about 1 to 3 million, preferred cationically modified polyacrylamide compounds have weight average molecular weights in the range of approximately 3 to 5 million, and anionically modified polyacrylamide compounds are preferably present in an average molecular weight range of from 1 to a few million.

In general, there are two types of tape joint compounds or gypsum mortars: 1) drying and 2) setting. Both generally comprise gypsum and further comprise one or more filler.

Drying compositions may be provided as ready-to-use dry mix compositions or as liquid tape joint compounds and calcium carbonate or limestone is the predominant inorganic filler. For storage, water can be mixed in with the inorganic filler and does not react with the inorganic filler. Upon application, the water evaporates to the atmosphere.

Setting compositions can be sold as a dry mix powder and water must not be added until used at the job site or else the dry mix blocks up in the package and becomes useless. The primary inorganic filler is calcium sulfate hemihydrate and the water does react with the filler, thus, the term setting. Preferably, the composition of the present invention is a drying composition and is a tape joint or gypsum smoothing compound (liquid) composition or a dry mix composition.

The dry mix and liquid compound compositions of the present invention comprise gypsum in an amount not less than 10 wt. %, preferably, 40 wt. % or more, or, more preferably, 60 wt. % or more, and even more preferably 80 wt. % or more, based on the total dry weight of the compositions.

The compositions of the present invention can include inorganic fillers. The level of inorganic filler ranges from 40 to 80 wt. %, preferably from 60 to 70 wt. %, based on the weight of the dry mix or aqueous mortar or compound.

The predominant inorganic filler may be calcium carbonate, usually derived from limestone. Other inorganic fillers that can be used include), mica, clay, expanded perlite, and talc.

The dry mix or mortar may be substantially free from inorganic fillers or materials that react with other components of the composition such as water, in particular, calcium sulfate hemihydrate.

The liquid tape joint compound compositions of the present invention may further include an emulsion polymer binder formed by an aqueous emulsion polymerization method. Aqueous emulsion polymers may be selected from various compositional classes such as, for example, vinyl acetate polymers, vinyl acetate-acrylic copolymers, vinyl acetate-ethylene copolymers, acrylic polymers, styrene-butadiene copolymers, and blends thereof.

The emulsion polymer binder may be supplied as an aqueous dispersion of polymer or, for use in a dry mix composition in a solid form as a water redispersible polymer powder resulting, for example, from the spray-drying of the aqueous emulsion polymer.

Other ingredients such as biocides, organic or inorganic thickening agents and/or secondary water retention agents, anti-sag agents, air entraining agents, wetting agents, defoamers, dispersants, calcium complexing agents, retarders, accelerators, water repellents, water redispersible polymer powders, biopolymers, fibres and surfactants may be included in the compositions of the present invention. All of these other ingredients are known in the art and are available from commercial sources. Such additional additives may also be mixed with the gypsum-free mixture of the present invention.

The pH of any mortar is typically in the range of from 3 to 11, preferably, in the range of from 6 to 8. The viscosity of the aqueous tape joint compound or mortar is typically in the range of 400 to 800 Braebender units (“BU”) at 25° C.

The compositions of the present invention as dry mixes or wet compounds find use as gypsum smoothing mortars and are applied very thin for finishing for walls, wallboards or over plaster, for example, from 0.5 to 10 or less than 7 mm in thickness.

In addition, the compositions of the present invention find use as tape joint compounds and dry mix tape joint compounds, which are mixed with water at the time of use. These are generally applied by hand after mixing (if needed) over sheet rock with joint tape.

Aqueous tape joint compounds are generally applied, for example, to a wall board panel with a broad knife or with a mechanical tool which simulates the action of a broad knife trowelling the tape joint compound. Drying is typically allowed to proceed under ambient conditions such as, for example, at from 10° C. to 40° C.

### EXAMPLES

The following materials were used.

Drying gypsum dry powder (CASUTEC™ WS Casea GmbH, Ellrich, DE), containing no cellulose ether. The cellulose ether was a hydroxyethyl methylcellulose available as WALOCEL™ MKX 25000 cellulose ether (Dow Wolff Cellulosics GmbH, DE). Viscosity given below.

### Examples 1 to 4

### Incorporation of PCE Superplasticizer Onto the Cellulose Ether

A wet filter cake of hydroxyethyl methylcellulose (NEMC) was added to a heated laboratory scale (4-6 liter volume) kneading machine (Werner & Pfleiderer Masch.Typ: LUK 4 III-1, Coperion, Stuttgart, DE) set at 70° C., and kneaded continually for 30 minutes at a shear rate of from 25 to 50 rpm. A PCE polymeric fluidizer was dosed in (polymethacrylic acid having polyethylene oxide and methyl end capped polyethylene oxide ester side chains, Glenium™ 51 35 wt. % aq. PCE solution, BASF, Ludwigshafen, DE) for less than 10 minutes. The mixture was kneaded 20 min at a shear rate from 25 to 50 rpm and the product afterwards dried in a drying cabinet at 55° C. and ground in an Alpine mill (Hosokawa Alpine Aktiengesellschaft, Augsburg, DE) equipped with an 0.5 mm sieve for a time sufficient that 100 wt. % of the product passes through the sieve to form a dry mix additive. Then, the particle size was adjusted with a standard sieve so that the product has an average particle size of at least 30 wt. %<63 μm.

As shown in Table 1, below, the grade of HEMC used and compared had consistent viscosities.

TABLE 1
Wet Viscosity of Polymeric Fluidizer Cellulose Ether Mix

| Samples | Comp | 1 | 2 | 3 | 4 |
|---|---|---|---|---|---|
| HEMC V2* [mPas] | 20000-25000 | 21910 | 24610 | 21640 | 19090 |
| PCE [%] | 0 | 0.5 | 1.0 | 2.5 | 5.0 |

*Viscosity: 2% aq. solution, Haake Rotovisko RV 100, shear rate 2.55 s⁻¹, 20° C.

Not shown in Table 1, above, the polyacrylamide was dry and had a 30 wt. % anionic charge and a viscosity of 1600 mPas (concentration 1 wt. % in water at 2.51 s⁻¹, with 10% NaCl at RT); this was included in the composition by adding it to the ground cellulose ether dry mix additive and dry mixing to make the final additive product. The dry polyacrylamide has the proper particle size as provided.

Test Method: 200 g of drying gypsum smoothing mortar and joint filler raw material was dry blended with 1.0 g of the dry mix additive and mixed in a plastic cup with tap water; the mortar was mixed for 45 sec with a wooden stick after a waiting time of 15 sec. The workability was evaluated immediately after stirring, as shown in Table 2, below. After 10 min. resting time the mortar was stirred again and the workability was evaluated, as shown in Table 2, below. Workability was evaluated visually for the formation of lumps. It is indicated whether or not these are present and if so to what degree: 1 is best; 5 is worse, 2 is good. Ease of movement and the stirring test refers to thickening power which is evaluated at the start and end of observed thickening and after stirring; this is judged in comparison to the comparative Example and a number larger than 100 indicates a stronger thickening and less ease of stirring while a number smaller than 100 indicates less pronounced thickening.

TABLE 2
Workability

| Formulation: | | Comp | 1 | 2 | 3 | 4 | Dim |
|---|---|---|---|---|---|---|---|
| Comp | | 96 | | | | | % |
| Polyacrylamide | | 4 | 4 | 4 | 4 | 4 | % |
| Additive 1 | | | 96 | | | | % |
| Additive 2 | | | | 96 | | | % |
| Additive 3 | | | | | 96 | | % |
| Additive 4 | | | | | | 96 | % |
| water demand | | 0.50 | 0.50 | 0.50 | 0.50 | 0.50 | — |
| Stirring test | KU-40 | | | | | | |
| | start of thickening | 5-7 | 5-7 | 5-7 | 5-7 | 5-7 | s |
| | end of thickening | 40 | 40 | 40 | 40 | 40 | s |
| | ease of movement | 100 | 105 | 105 | 105 | 110 | % |
| Workability after 10 min. | | | | | | | |
| | Workability | 3 | 3 | 2-3 | 2 | 2 | — |
| | Workability | good | good | better | good | good | — |
| | | smoothing | sliding | sliding and | sliding | sliding | |
| | | | and | good | and | and | |
| | | | smoothing | smoothing | smoothing | smoothing | |

As shown in Table 2, above, the composition of Examples 1 to 4 thickens better than the comparative and gives better ease of movement and application. Further, the ease of movement improves more with more of the PCE coating the cellulose ether particle surface in the dry mix additive.

### Examples 5-10

### Incorporation of Polymeric Colloidal Stabilizers Into Cellulose Ether

As shown in Table 3, below, a wet filter cake (601 g, 41.1 wt. % solids content) of synthesized hydroxyethyl methylcellulose [NEMC; DS(M)=1.54; MS(HE)=0.31] was added to a heated kneading machine (Werner & Pfleiderer Masch.Typ: LUK 4 III-1, Coperion, Stuttgart, DE) set at 70° C. and kneaded for 30 minutes. A 20 wt. % aqueous solution of 88% hydrolysed PVOH (Mowiol™ 4-88 LA, Kuraray Europe GmbH., Hattersheim am Main, DE) was combined in within 10 minutes. This mixture was kneaded 20 min and the product afterwards dried in a drying cabinet at 55° C. and ground in an Alpine mill (Hosokawa Alpine Aktiengesellschaft, Augsburg, DE) equipped with an 0.5 mm sieve for a time sufficient that 100 wt. % of the product passes through the sieve to form a dry mix additive. Then, the particle size was adjusted with a standard sieve so that the product has an average particle size of at least 30 wt. %<63 μm.

TABLE 3
Polymeric Colloidal Stabilizer Compositions

| Samples | Comp | 5 | 6 | 7 | 8 | 9 | 10 |
|---|---|---|---|---|---|---|---|
| HEMC V2* | 21730 | 22310 | 24260 | 22500 | 25500 | 22630 | 21780 |
| [mPas] | | | | | | | |
| PVOH [%] | 0 | 0.1 | 0.25 | 0.5 | 1 | 3 | 5 |

*Viscosity −2% aqu. solution, Haake Rotovisko RV 100, shear rate 2.55 s⁻¹, 20° C.

Not shown in Table 3, above, a dry polyacrylamide (30 wt. % anionic charge and a viscosity of 1600 mPa·s at a concentration 1 wt. % in water at 2.51 s⁻¹, with 10% NaCl at RT) was included in the composition by adding it to the ground cellulose ether dry mix additive and dry mixing. The dry polyacrylamide has the proper particle size as provided.

Application tests: The compositions were tested by forming a mortar. In each composition, 800 g of gypsum raw material was dry blend with 0.5 wt. % (solids) of the polymeric additive modified cellulose ether. Water was added to a plastic cup; and afterwards the dry mortar was added. With a standard kitchen mixer (Krups GmbH, Offenbach am Main, DE), the water/dry ingredients were mixed with low speed for 5 s and afterwards directly 55 s with high speed. After a resting time of 10 min the wet mortar was mixed again 15 s with high speed. Then, prisms were prepared from the compositions.

Prisms preparation: A mold of expanded polystyrene (EPS) with a rectangular female mold shape (40 mm×40 mm×160 mm) was filled with each mortar half-full and then manually compressed by rapping the bottom of the filled mold against a hard flat surface or swaged 5 times. Then rest of each mold was filled and swaged again 20 times. Each mold was covered with a polyethylene film and allowed to dry. After 2 day cured, the mortar was removed from the prisms and stored again for 5 days in a PE plastic bag. After the 5 days, the prisms were stored under normal climate conditions (23° C./50% moisture) for an additional 21 days.

Flexural and compressive strength measurement: After cure, 3 prisms were used to measure the flexural strength at a force of 0.25 KN/s by trying to bend the prisms in a Tonitrol Druck und Biegezug Prüfanlage (Bluhm & Feuerherdt GmbH, Berlin, DE) according to DIN EN 196-1 (2005-05). Afterwards the 7 pieces from the flexural strength measurement were used to measure the compressive strength at a force of 0.7 KN/s using the same equipment as in the flexural test to compress the molded prisms. Results are shown in Table 4, below.

TABLE 4
Strength Test Results

| | | Compressive | |
|---|---|---|---|
| Example | Flexural strength | strength | Dim. |
| HEMC - Comp | 2.353 | 6.93 | N/mm² |
| 5 | 2.786 | 6.40 | |
| 6 | 3.965 | 9.89 | |
| 7 | 2.881 | 8.45 | |
| 8 | 3.123 | 8.76 | |
| 9 | 4.043 | 9.84 | |
| 10 | 4.548 | 9.87 | |

As shown in Table 4, above, the compositions of the present invention improved the flexural and compressive strength of the cured mortar as a function of the amount of the polymeric colloidal stabilizer polymeric additive of the present invention. The more of the additive used, the better the strength which was much better than cellulose ethers alone.

We claim:

1. A method for making compositions for use as gypsum dry mix or gypsum tape joint compound additives comprise kneading at elevated temperature of from 50 to 120° C. a wet cellulose ether mixture containing from 60 to 80 wt. % of water, one or more cellulose ether, and from 0.1 to 10 wt. %, based on total cellulose ether solids, of a polymeric additive chosen from polymeric colloidal stabilizers, polymeric fluidizers, and combinations thereof to form an additive; drying and grinding the additive; and, then combining the additive with 0.1 to 20 wt. %, based on total cellulose ether solids, of one or more dry polyacrylamide.

2. The method as claimed in claim 1, wherein the kneading device comprises an extruder, a kneader, a banbury mixer; a high shear mixer, or a homogenizer.

3. The method as claimed in claim 1, wherein the cellulose ether is hydroxyethyl methyl cellulose.

4. The method as claimed in claim 1, wherein the amount of polymeric additive ranges from 0.2 to 5 wt. %, based on total cellulose ether solids.

5. The method as claimed in claim 1, wherein the polymeric additive is a polymeric colloidal stabilizer which is a polyvinyl alcohol.

6. The method as claimed in claim 1, wherein the polymeric additive is a polymeric colloidal stabilizer present in the mixture as an aqueous composition having from 5 to 30 wt. % solids.

7. The method as claimed in claim 1, wherein the polymeric additive is a polymeric fluidizer chosen from a polycarboxylate ether, and a melamin/formaldehyde sulfonate.

8. The method as claimed in claim 7, wherein the polymeric fluidizer is a polycarboxylate ether which is a polyacrylic or polymethacrylic acid containing one or more alkylpolyglycol ether side chains.

9. The method as claimed in claim 1, wherein the polymeric additive is a polymeric fluidizer present in the mixture as an aqueous composition having from 10 to 50 wt. % solids.

10. A dry mix composition comprising gypsum or calcium sulfate and a dry mix additive comprising one or more cellulose ether powders wherein the powder of cellulose ethers contains on its surface from 0.1 to 10 wt. %, based on total cellulose ether solids, of a polymeric additive chosen from polymeric colloidal stabilizers, polymeric fluidizers and combinations thereof; the dry mix additive further comprising a polyacrylamide in the amount of from 0.1 to 20 wt. %, based on total cellulose ether solids.
